(19) United States
(12) Patent Application Publication
(10) Pub. No.: US 2023/0264365 A1
(43) Pub. Date: Aug. 24, 2023

(54) INFORMATION PROCESSING APPARATUS, INFORMATION PROCESSING METHOD, AND COMPUTER PROGRAM

(71) Applicant: SONY GROUP CORPORATION, TOKYO (JP)

(72) Inventor: KEISUKE MAEDA, TOKYO (JP)

(21) Appl. No.: 18/006,912

(22) PCT Filed: Jun. 22, 2021
(86) PCT No.: PCT/JP2021/023567

§ 371 Date: Jan. 26, 2023

(30) Foreign Application Priority Data
Aug. 17, 2020 (JP) 2020-137681

(51) Int. Cl. B25J 13/08; B25J 9/16

(52) U.S. Cl. CPC B25J 13/08; B25J 9/1661

(57) ABSTRACT

Provided is an information processing apparatus that processes information for implementing the best gripping operation suitable for a characteristic of a gripper.

The information processing apparatus includes: a grip information analysis unit that analyzes an object and generates generalized grip shape information; and a generalized grip shape information accumulation unit that accumulates the generalized grip shape information. The information processing apparatus further includes a grip objective planning unit that plans a grip objective of the object on the basis of the generalized grip shape information of the object and a characteristic of a gripper to be used for a grip. The grip objective planning unit plans the grip objective regarding how to grip which portion of the object.

### TECHNICAL FIELD

The technology disclosed in the present specification (hereinafter, “present disclosure”) relates to an information processing apparatus and an information processing method that process information for gripping an object with a gripper, and a computer program.

### BACKGROUND ART

In recent years, robots have become widespread, and robots have been introduced into various fields such as factories, logistics, and medical care. Accordingly, opportunities to grip arbitrary objects having different shapes, sizes, weights, materials, and the like using a manipulator and a gripper have been increasing.

Methods for recognizing a shape of a target material by a visual sensor and gripping an object have been widely known. For example, there is proposed a method of gripping an arbitrarily-shaped object by a robot in which a simple shape approximate to a shape of a target object is obtained from among several types of predetermined simple shapes by image recognition from an image of the target object acquired by a visual sensor, an appropriate gripping method is selected from square gripping and circular gripping on the basis of the obtained simple shape and its orientation and size, a grip point of each of fingers of a hand of the robot is calculated according to the selected gripping method, and the respective fingers are controlled to perform a gripping operation (see Patent Document 1).

In this gripping method, however, a gripping method is derived according to the robot hand having a specific characteristic, and in the case of a robot that replaces a hand or a robot equipped with a plurality of hands having different characteristics, it is necessary to perform approximation to a simple shape, selection of a gripping method for the approximated simple shape, and calculation of a grip point of each of the fingers suitable for the selected gripping method for each of the hands to be used (alternatively, for each of the characteristics of the hands), so that a processing load of the calculation is large.

### CITATION LIST

### Patent Document

Patent Document 1: Japanese Patent Application Laid-Open No. 2005-169564

### SUMMARY OF THE INVENTION

### Problems to be Solved by the Invention

An object of the present disclosure is to provide an information processing apparatus that processes information for gripping an object regardless of a gripper type, an information processing method, and a computer program.

### Solutions to Problems

The present disclosure has been made in view of the above-described problem, and a first aspect thereof is

an information processing apparatus including:

a grip information analysis unit that analyzes an object and generates generalized grip shape information; and

a generalized grip shape information accumulation unit that accumulates the generalized grip shape information.

The grip information analysis unit estimates a centroid position of the object on the assumption of a uniform material from a shape, a volume, or an appearance of the object. The grip information analysis unit obtains centroids respectively for estimated materials of the object including a plurality of materials and estimate the centroid position by taking a weighted average of the centroids. Furthermore, the grip information analysis unit extracts a surface shape of the object, divides the surface shape of the object into a plurality of flat surfaces or curved surfaces, and, for each of the divided surfaces, estimates flatness and a normal direction of the surface on the basis of a variance of elements constituting the surface, estimates an opening distance in the normal direction of the divided surface on the basis of the normal direction, and estimates friction and strength of the object on the basis of the flatness, reflected light, or an estimated material to generate the generalized grip shape information.

Furthermore, the information processing apparatus according to the first aspect further includes a grip objective planning unit that plans a grip objective of the object on the basis of the generalized grip shape information of the object and a characteristic of a gripper to be used for a grip. The grip objective planning unit selects a divided surface to be a grip surface candidate from among a plurality of divided surfaces obtained by dividing a surface shape of the object, which is an object to be gripped and determines a combination of the grip surface and a finger of the gripper from among a plurality of the grip surface candidates to determine the grip objective.

Furthermore, a second aspect of the present disclosure is

an information processing method including:

a grip information analysis step of analyzing an object and generating generalized grip shape information; and

a generalized grip shape information accumulation step of accumulating the generalized grip shape information in a generalized grip shape information accumulation unit.

Furthermore, a third aspect of the present disclosure is

a computer program recorded in a computer-readable format to cause a computer to function as:

a grip information analysis unit that analyzes an object and generates generalized grip shape information; and

a generalized grip shape information accumulation unit that accumulates the generalized grip shape information.

A computer program according to a third aspect of the present disclosure defines a computer program described in a computer-readable format so as to implement predetermined processing on a computer. In other words, by installing the computer program according to the third aspect of the present disclosure in the computer, cooperative functions are exerted on the computer, and it is possible to obtain functions and effects similar to those of the information processing apparatus according to the first aspect of the present disclosure.

### Effects of the Invention

According to the present disclosure, it is possible to provide the information processing apparatus and the information processing method that process information for implementing the best gripping operation suitable for the characteristic of the gripper, and the computer program.

Note that the effects described in the present specification are merely examples, and effects brought by the present disclosure are not limited thereto. Furthermore, there is also a case where the present disclosure further provides additional effects in addition to the effects described above.

Still other objects, characteristics and advantages of the present disclosure will become apparent from a detailed description based on embodiments as described later and accompanying drawings.

### BRIEF DESCRIPTION OF DRAWINGS

FIG. 1 is a diagram illustrating a functional configuration example of an information processing apparatus 100.

FIG. 2 is a diagram illustrating an example of generalized grip shape information 112.

FIG. 3 is a diagram illustrating an example of a grip objective 114.

FIG. 4 is a diagram illustrating an example of the grip objective 114.

FIG. 5 is a diagram illustrating a functional configuration example of a robot control system 500.

FIG. 6 is a flowchart illustrating a processing procedure for analyzing grip information of an object.

FIG. 7 is a flowchart illustrating a processing procedure for selecting a grip surface candidate from a plurality of divided surfaces of an object which is an object to be gripped.

FIG. 8 is a flowchart illustrating a processing procedure for determining a combination of grip surfaces from grip surface candidates.

FIG. 9 is a diagram illustrating a functional configuration example of a robot control system 900.

FIG. 10 is a diagram illustrating a hardware configuration example of an apparatus 1000 operating as the information processing apparatus 100.

### MODE FOR CARRYING OUT THE INVENTION

Hereinafter, the present disclosure will be described in the following order with reference to the drawings.

A. Basic Configuration

B. Configuration Example of Robot Control System

C. Grip Information Analysis Processing

D. Grip Surface Candidate Selection Processing

D-1. Selection of Grip Surface Candidate

D-2. Determination of Combination of Grip Surfaces

E. Modified Example of Robot Control System

G. Effects

### A. Basic Configuration

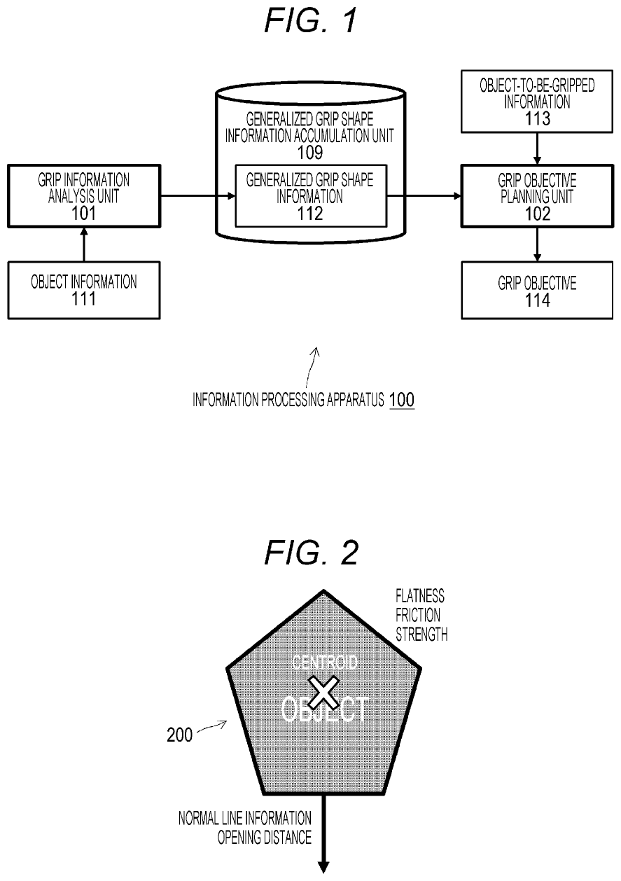

FIG. 1 schematically illustrates functional configurations of an information processing apparatus 100 according to the present disclosure. The information processing apparatus 100 is configured using, for example, a personal computer (PC) or the like. In FIG. 1, however, all constituent elements other than basic constituent elements are omitted in order to simplify the drawing.

The information processing apparatus 100 illustrated in FIG. 1 includes a grip information analysis unit 101, a grip objective planning unit 102, and a generalized grip shape information accumulation unit 109.

The grip information analysis unit 101 receives an input of object information 111, recognizes a shape of an object and a physical characteristic related to a grip, and outputs generalized grip shape information 112. The object information 111 is information regarding characteristics of the object, and includes, for example, a type, a position, a posture, a shape, an estimated material, strength, a weight, a centroid position, and the like of the object. The grip information analysis unit 101 divides a surface shape of the object into a plurality of flat surfaces or curved surfaces, calculates a grip characteristic for each of the divided surfaces, and outputs the grip characteristics as the generalized grip shape information 112 (not depending on a characteristic of a gripper).

The generalized grip shape information 112 includes a positional relationship between the respective surfaces obtained by dividing the surface shape of the object and grip characteristics of the respective surfaces. As a premise for the grip objective planning unit 102 to plan various grip objectives of various objects, it is assumed that pieces of the object information 111 of the various objects are input to the grip information analysis unit 101, pieces of the generalized grip shape information 112 of the respective objects are generated by the grip information analysis unit 101, and the generalized grip shape information 112 for each object type is accumulated in the generalized grip shape information accumulation unit 109.

When object-to-be-gripped information 113 is input, the grip objective planning unit 102 takes out the generalized grip shape information 112 of an object specified by the object-to-be-gripped information 113 from the generalized grip shape information accumulation unit 109, and calculates a grip objective 114 on the basis of the corresponding generalized grip shape information 112 and a characteristic of a gripper to be used for a grip.

The object-to-be-gripped information 113 is information for identifying an object which is an object to be gripped, and includes an object type, an object identifier, and the like. The grip objective 114 is target information regarding how to grip which portion of an object, and includes information such as a contact surface, a contact direction, and a contact force of each of the fingers of a gripper that comes into contact with the object when the gripper grips the object.

FIG. 2 illustrates an example of the generalized grip shape information 112 calculated by the grip information analysis unit 101. The grip information analysis unit 101 divides a surface shape of an object 200 into a plurality of flat surfaces or curved surfaces. In the example illustrated in FIG. 2, the grip shape analysis unit 101 divides the object 200 into surfaces of a pentagon. Then, the grip shape analysis unit 101 calculates flatness, friction, strength, normal line information, and an opening distance for each of the surfaces obtained by dividing the object 200, and outputs the generalized grip shape information 112 including pieces of the calculated information. The opening distance is a distance to a collision with an obstacle in a normal direction of the divided surface.

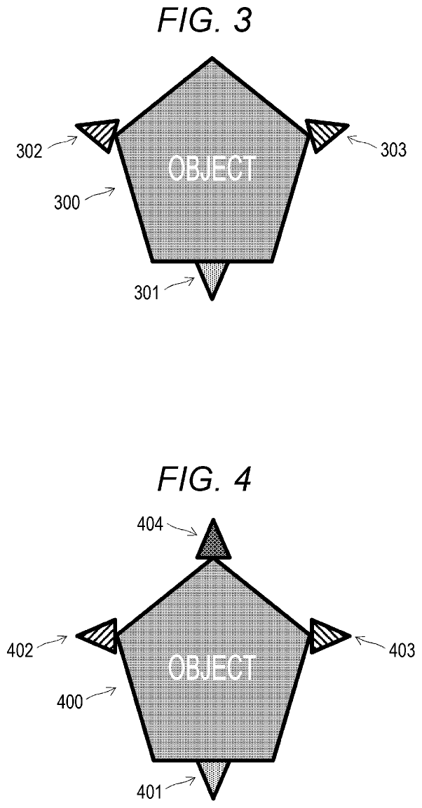

FIGS. 3 and 4 respectively illustrate examples of the grip objective 114 calculated by the grip objective planning unit 102. The grip objective planning unit 102 calculates the grip objective 114 on the basis of the generalized grip shape information 112 of an object specified by the object-to-be-gripped information 113. The grip objective 114 is target information regarding how to grip which portion of an object, and includes information such as a contact surface, a contact direction, and a contact force of each of the fingers of a gripper that comes into contact with the object when the gripper grips the object. FIG. 3 illustrates a contact surface and a contact direction of each finger in a case where a pentagonal object 300 is gripped by three fingers 301 to 303 of a gripper. Furthermore, FIG. 4 illustrates a contact surface and a contact direction of each finger in a case where a pentagonal object 400 is gripped by four fingers 401 to 404 of a gripper.

### B. Configuration Example of Robot Control System

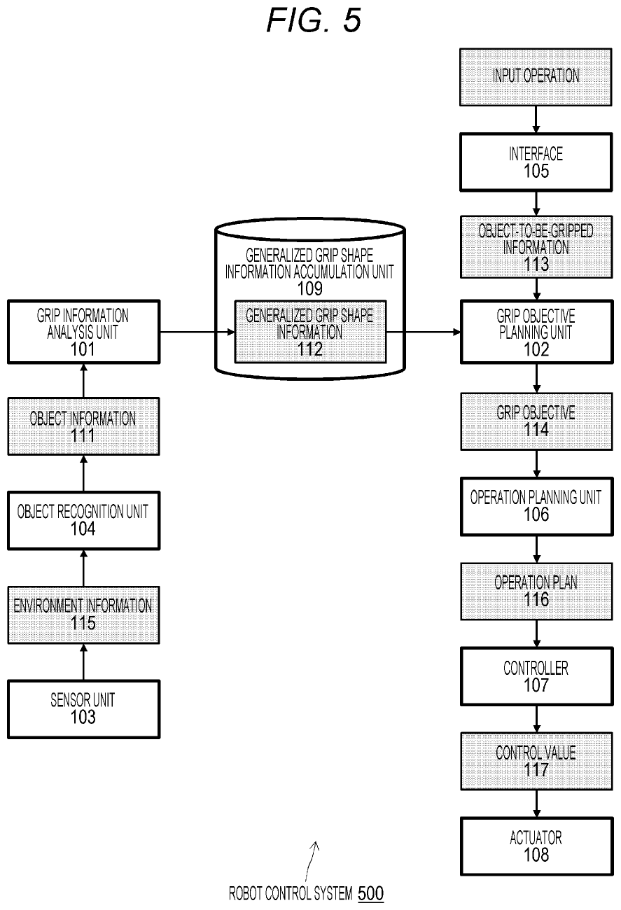

FIG. 5 illustrates a functional configuration example of a robot control system 500 configured by incorporating the information processing apparatus 100 according to the present disclosure. However, what is the same as the constituent element of the information processing apparatus 100 illustrated in FIG. 1 is denoted by the same reference sign. The robot control system 500 includes the grip information analysis unit 101, the grip objective planning unit 102, a sensor unit 103, an object recognition unit 104, an interface 105, an operation planning unit 106, a controller 107, and an actuator 108.

Constituent elements in the left half of the robot control system 500 illustrated in FIG. 5 mainly perform processing for generating the generalized grip shape information 112.

The sensor unit 103 is an observation device that acquires environment information 115 around a manipulator or a gripper (not illustrated) of a robot which is an object to be controlled. The sensor unit 103 includes, for example, a camera, a depth camera, or the like. The sensor unit 103 is not necessarily mounted on the robot as the object to be controlled, and may be, for example, a fixed camera installed in a work space of the robot.

The object recognition unit 104 detects the presence or absence of an object from the environment information (sensor data) 115 observed by the sensor unit 103, and calculates the object information 111 such as a position, a posture, and a type of each detected object. The object recognition unit 104 may perform object recognition using, for example, a machine learning model subjected to deep learning.

The grip information analysis unit 101 receives an input of the object information 111, divides a surface shape of an object into a plurality of flat surfaces or curved surfaces, calculates a grip characteristic for each of the divided surfaces, and outputs the generalized grip shape information 112 (not depending on a characteristic of a gripper).

Constituent elements in the right half of the robot control system 500 illustrated in FIG. 5 perform processing for controlling an operation of gripping an object specified by a user with a gripper using the generated generalized grip shape information 112.

The interface 105 performs processing for receiving the object-to-be-gripped information 113 from an input operation of the user (alternatively, a host system). The object-to-be-gripped information 113 is information for identifying an object which is an object to be gripped, and includes an object type, an object identifier, and the like.

Note that, in a case where the generalized grip shape information 112 of an object specified as the object to be gripped by the user or the host system has not yet been calculated by the grip information analysis unit 101, the interface 105 may instruct the sensor unit 103 to acquire the environment information 115 including the object.

The grip objective planning unit 102 calculates the grip objective 114 on the basis of the generalized grip shape information 112 of the object specified by the object-to-be-gripped information 113 and a characteristic of the manipulator and the gripper (not illustrated) of the robot as the object to be controlled. The grip objective 114 is target information regarding how to grip which portion of an object, and includes information such as a contact surface, a contact direction, and a contact force of each of the fingers of a gripper that comes into contact with the object when the gripper grips the object.

According to the present disclosure, the generalized grip shape information 112 of an object is information indicating a grip characteristic of the object not depending on a characteristic of a gripper. The grip objective planning unit 102 calculates the grip objective 114 suitable for a characteristic of a gripper actually used for gripping the object from the generalized grip shape information 112. Therefore, even when a gripper of a robot is replaced or any gripper is selected in a robot equipped with a plurality of grippers having different characteristics, the grip objective planning unit 102 can adaptively calculate the grip objective 114 suitable for a characteristic of the gripper.

When the grip objective 114 is input, the operation planning unit 106 calculates an operation plan 116 of the manipulator and the gripper (not illustrated) of the robot as the object to be controlled on the basis of mechanism information of the manipulator and the gripper. The operation plan 116 is time-series target information for operating the manipulator and the gripper, and includes an array of a position, a speed, and a torque target of each joint of the manipulator, an array of a position, a posture, a speed, and a torque target of the gripper, and the like.

The controller 107 receives an input of the operation plan 116 and generates a control value 117 for driving the actuator 108 such that the manipulator and the gripper operate according to the operation plan 116.

The actuator 108 includes motors that drive the respective joints of the manipulator and the gripper, and the like. The actuator 108 is driven on the basis of the control value 117 output from the controller 107.

### C. Grip Information Analysis Processing

The grip information analysis unit 101 receives an input of object information 111, recognizes a shape of an object and a physical characteristic related to a grip, and outputs generalized grip shape information 112. The generalized grip shape information 112 includes a positional relationship between the respective surfaces obtained by dividing the surface shape of the object and grip characteristics of the respective surfaces.

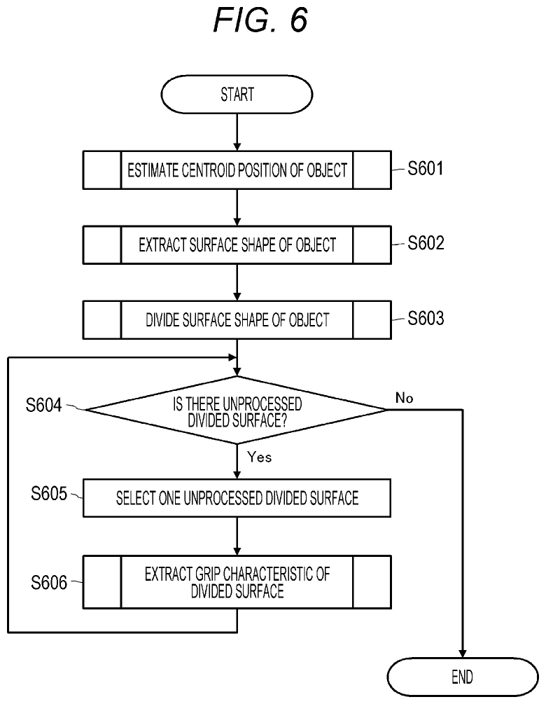

FIG. 6 illustrates a processing procedure for analyzing grip information of an object in the grip information analysis unit 101 in a flowchart format.

First, the grip information analysis unit 101 estimates a centroid position of the object on the basis of the input object information 111 (step S601). The grip information analysis unit 101 estimates the centroid position on the assumption of a uniform material from a shape, a volume, and an appearance of the object. Furthermore, in the case of an object including a plurality of materials, the grip information analysis unit 101 obtains centroids respectively for the estimated materials and estimates a centroid position by taking a weighted average thereof.

Next, the grip information analysis unit 101 extracts a surface shape of the object (step S602). The grip information analysis unit 101 may extract the surface shape by a method such as boundary extraction or edge extraction.

In a case where a point cloud or depth information of an object area is obtained as the object information 111, the grip information analysis unit 101 extracts a 3D surface shape. Examples of a data format in this case include a point cloud, a mesh, a polyhedron, and the like. Furthermore, in the case of an object whose 2D shape has been obtained from a bird's-eye view image or the like, the grip information analysis unit 101 extracts information regarding a boundary line. Examples of a data format in this case include a curve, a polygon, and the like.

Next, the grip information analysis unit 101 divides a surface shape of the object into a plurality of flat surfaces or curved surfaces (step S603). The grip information analysis unit 101 applies, for example, flat surface detection or straight line detection with respect to the target object, and sets extracted portions respectively as the divided surfaces. Furthermore, a portion where no straight line has been detected may be one curved surface.

Thereafter, the grip information analysis unit 101 repeatedly executes a process of selecting one unprocessed divided surface (step S605) and extracting a grip characteristic of the divided surface (step S606) until the process is executed for all the divided surfaces (Yes in step S604). The grip shape analysis unit 101 estimates flatness and a normal direction of each of the divided surfaces from a variance of elements constituting the surface, estimates an opening distance of the divided surface in the normal direction on the basis of the normal direction, or estimates friction and strength of the object on the basis of flatness, reflected light, and the estimated material, and outputs the estimated characteristics as the generalized grip shape information 112. Furthermore, the grip information analysis unit 101 estimates a relative position between each of the divided surfaces and the centroid estimated in step S601 and a posture.

Then, the grip information analysis unit 101 outputs the grip characteristics extracted for each of the divided surfaces as the generalized grip shape information 112. The generalized grip shape information 112 includes a positional relationship between the respective surfaces obtained by dividing the surface shape of the object and grip characteristics of the respective surfaces.

### D. Planning of Grip Objective

The grip objective planning unit 102 calculates the grip objective 114 for an object on the basis of the generalized grip shape information 112 of the object. The grip objective 114 is target information regarding how to grip which portion of an object, and includes information such as a contact surface, a contact direction, and a contact force of each of the fingers of a gripper that comes into contact with the object when the gripper grips the object.

The grip objective planning unit 102 first selects a divided surface as a grip surface candidate from among a plurality of divided surfaces obtained by dividing a surface shape of the object which is the object to be gripped, then determines a combination of each of the grip surfaces and each of the fingers of the gripper from among a plurality of grip surface candidates, and determines the grip objective 114. Hereinafter, a process of planning the grip objective 114 in two stages of selection of the grip surface candidate and determination of a combination of the grip surfaces will be described.

D-1. Selection of Grip Surface Candidate

First, the grip objective planning unit 102 evaluates a suitability of a grip of each of divided surfaces of an object which is an object to be gripped on the basis of characteristics of fingers of a gripper to be used for gripping the object, and removes a divided surface that is not suitable for the grip from candidates. Therefore, a divided surface that has not been removed from the candidates remains as a grip surface candidate. The grip objective planning unit 102 may record evaluation values of the divided surfaces that have not been excluded from the grip surface candidates, and use the evaluation values in the process of determining a combination of grip surfaces in the subsequent stage.

In a case where the gripper has a plurality of fingers having different characteristics, the grip objective planning unit 102 may evaluate the suitability of the grip each of the divided surfaces of the object, which is the object to be gripped, on the basis of the characteristic of each of the fingers. Then, the grip objective planning unit 102 removes a divided surface that is not suitable for a grip with respect to any finger having any characteristic from the candidates. Alternatively, the divided surfaces in which the number of fingers facing the grip is small may be excluded from the candidates.

Furthermore, the grip objective planning unit 102 may evaluate the suitability of the grip each of the divided surfaces for a plurality of evaluation items. Then, the grip objective planning unit 102 removes a divided surface having a low evaluation value for at least one evaluation item from the grip surface candidates. Alternatively, the grip objective planning unit 102 may exclude a divided surface in which the total or average value (including a weighted average) of the evaluation values of the plurality of evaluation items is less than a predetermined threshold from the grip surface candidates.

For example, a thickness of a finger of the gripper and an opening distance of a divided surface in a normal direction may be set as one of the evaluation items for selection of the grip surface candidate. The opening distance is a distance to a collision with an obstacle in the normal direction of the divided surface. When the opening distance in the normal direction is smaller than the thickness of the finger, it is difficult to insert the finger into a gap between a divided surface and an obstacle, and it is difficult to perform a grip using the divided surface. Therefore, if the opening distance in the normal direction is shorter than the thickness of the finger, the grip objective planning unit 102 may remove the divided surface from the grip surface candidates.

Furthermore, for example, slipperiness of a finger with respect to a divided surface may be set as one of the evaluation items for selection of the grip surface candidate. It is possible to evaluate the slipperiness of the finger with respect to the divided surface when a grip is performed by bringing the finger into contact with the divided surface from a friction coefficient of the finger, an estimated friction coefficient of the divided surface, a gripping force, and an estimated weight of the object. If the grip is performed using a slippery surface, there is a possibility that the finger slips to drop the object. Therefore, the grip objective planning unit 102 may remove a divided surface on which the finger easily slips from the grip surface candidates.

Furthermore, for example, an elastic modulus of a finger and flatness of a divided surface may be set as one of the evaluation items for selection of the grip surface candidate. If the flatness of the divided surface is low even though deformation hardly occurs due to the finger having a high elastic modulus, a contact surface of the finger when a grip is performed using the divided surface is narrow and slippery. Therefore, when a gripper including the finger having the high elastic modulus is used, the grip objective planning unit 102 may remove a divided surface having low flatness from the grip surface candidates.

Furthermore, for example, an angle formed by a vector from an estimated centroid position of the object, which is the object to be gripped, to a divided surface and a normal direction of the divided surface may be set as one of the evaluation items of the selection of the grip surface candidate. If the angle is large, a large contact force is required to prevent a finger from slipping when a grip is performed using the divided surface so that the driving power of the actuator 108 increases. Therefore, the grip objective planning unit 102 may exclude, from the grip surface candidates, a divided surface in which the angle formed by the normal direction with respect to the vector from the estimated centroid position of the object, which is the object to be gripped, to the divided surface is large.

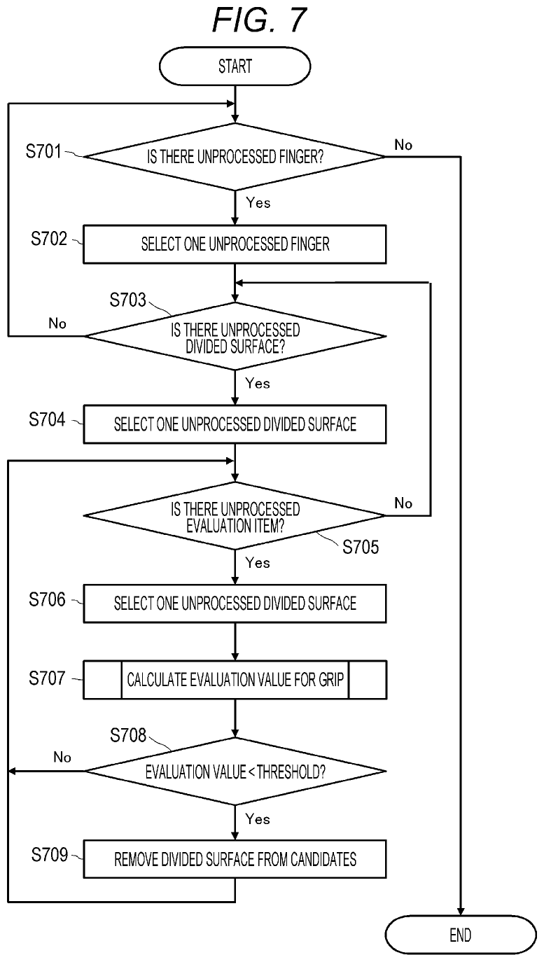

FIG. 7 illustrates a processing procedure for selecting a grip surface candidate from a plurality of divided surfaces of an object, which is an object to be gripped, in the grip objective planning unit 102 in a flowchart format. In the illustrated processing procedure, it is assumed that a plurality of fingers of a gripper has different characteristics, and each of the divided surfaces is evaluated using a plurality of evaluation items.

The grip objective planning unit 102 selects one unprocessed finger (step S702), and, in a case where there is an unprocessed divided surface (Yes in step S703), selects one unprocessed divided surface (step S704). Then, in a case where there is an unprocessed evaluation item (Yes in step S705), the grip objective planning unit 102 selects one unprocessed evaluation item (step S706), and calculates an evaluation value for a grip of the divided surface selected in step S704 on the basis of the characteristic of the finger selected in step S702 for the evaluation item (step S707).

The same evaluation items as those exemplified above are applied. It is assumed that a threshold is set in advance for each of the evaluation items. For example, thresholds are set respectively for an opening distance in a normal direction being equal to or larger than a thickness of the finger in the case of the thickness of the finger of the gripper and the opening distance in the normal direction of the divided surface, an estimated frictional force in the case of slipperiness of the finger with respect to the divided surface, an estimated contact area in the case of an elastic modulus of the finger and flatness of the divided surface, an angle formed by a vector from an estimated centroid position of the object, which is the object to be gripped, to the divided surface and the normal direction of the divided surface, and the like.

Then, in a case where the evaluation value calculated in step S707 is less than the threshold for the evaluation item selected in step S706 (Yes in step S708), the grip objective planning unit 102 removes the corresponding divided surface from grip surface candidates (step S709).

Thereafter, in a case where there is an unprocessed evaluation item for this divided surface (Yes in step S705), the grip objective planning unit 102 selects one unprocessed evaluation item (step S706), and repeatedly executes evaluation of the divided surface similar to one described above for the evaluation item.

Furthermore, in a case where the evaluation has been completed for all the evaluation items for this divided surface (No in step S705), the processing returns to step S703, and the grip objective planning unit 102 checks whether or not an unprocessed divided surface remains. Then, in a case where there is an unprocessed divided surface (Yes in step S703), the grip objective planning unit 102 selects one unprocessed divided surface (step S704), and repeatedly executes evaluation for each of the evaluation items for the divided surface in a similar manner as described above.

Furthermore, in a case where the evaluation has been completed for all the divided surfaces of the object, which is the object to be gripped, (No in step S703), the processing returns to step S701, and the grip objective planning unit 102 checks whether or not an unprocessed finger remains. Then, in a case where there is an unprocessed finger (Yes in step S701), the grip objective planning unit 102 selects one unprocessed finger (step S702), and repeatedly executes evaluation for each of the evaluation items for each divided surface of the object, which is the object to be gripped, on the basis of the characteristic of the finger in a similar manner as described above.

Then, when all the evaluation items of all the divided surfaces of the object have been evaluated for all the fingers (No in step S701), the grip objective planning unit 102 ends this processing.

D-2. Determination of Combination of Grip Surfaces

First, the grip objective planning unit 102 generates candidates for a combination of each of grip surface candidates selected according to the processing procedure illustrated in FIG. 7 and each of fingers of a gripper. Then, the grip objective planning unit 102 selects the best combination of the grip surface candidate and each of the fingers of the gripper from the plurality of candidates and outputs the selected combination as the grip objective 114.

When generating a combination of a grip surface candidate and a finger of the gripper, the grip objective planning unit 102 may assign a plurality of fingers to one grip surface. For example, in the case of a divided surface having a large area, it is more stable to grip the divided surface with the plurality of fingers.

Furthermore, when generating a combination of a grip surface candidate and a finger of the gripper, the grip objective planning unit 102 does not necessarily assign all the fingers of the gripper to the grip surfaces. That is, a combination of a grip surface candidate and a finger of the gripper that does not require use of a certain finger may be generated.

Furthermore, when generating a combination of a grip surface candidate and a finger of the gripper, the grip objective planning unit 102 does not necessarily need to assign any finger of the gripper to all the grip surface candidates. That is, a combination including grip surface candidates that are not gripped by any finger may be generated.

Then, the grip objective planning unit 102 calculates a grip evaluation value for each of the generated candidates for the combinations of the grip surface candidates and the fingers of the gripper, and outputs the grip objective 114 based on the combination candidate having the highest grip evaluation value.

A method of calculating the grip evaluation value for each of the candidates for the combinations of the grip surface candidates and the fingers of the gripper is not particularly limited. For example, a vector of a gripping force (including a frictional force) generated by each of the fingers gripping an object, which is an object to be gripped, may be calculated, and whether or not a resultant force with the gravity acting on the object can be set to zero may be confirmed.

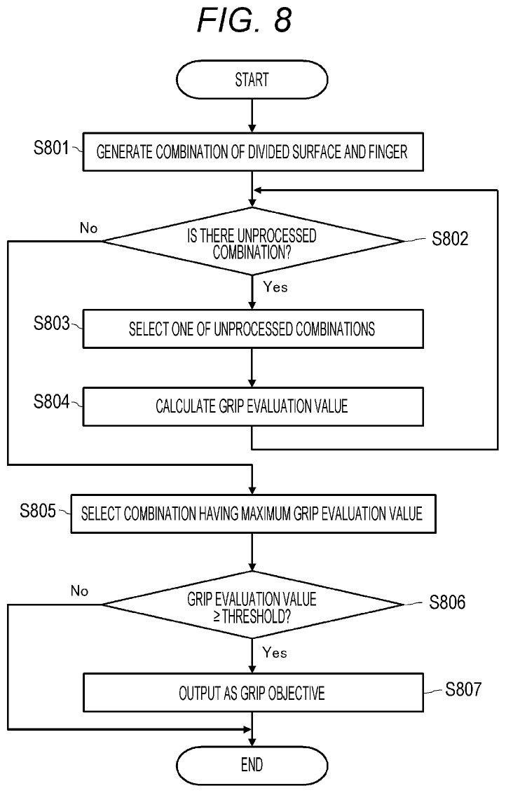

FIG. 8 illustrates a processing procedure for determining a combination of grip surfaces from grip surface candidates in the grip objective planning unit 102 in a flowchart format.

First, the grip objective planning unit 102 generates candidates for combinations of grip surfaces selected according to the processing procedure illustrated in FIG. 7 and each of fingers of a gripper (step S801).

Then, the grip objective planning unit 102 selects one unprocessed combination of a grip surface and a finger of the gripper (step S803) and calculates a grip evaluation value for the combination (step S804). A method of calculating the grip evaluation value for each of the candidates for the combinations of the grip surfaces and the fingers of the gripper is not particularly limited. For example, a vector of a gripping force (including a frictional force) generated by each of the fingers gripping an object, which is an object to be gripped, may be calculated, and whether or not a resultant force with the gravity acting on the object can be set to zero may be confirmed (as described above).

In a case where there is an unprocessed combination candidate of a grip surface and a finger of the gripper (Yes in step S802), the grip objective planning unit 102 further selects one of the combination candidates (step S803) and repeatedly calculates the grip evaluation value (step S804).

In a case where the calculation of the grip evaluation value has been completed for all the combination candidates of the grip surfaces and the fingers of the gripper (No in step S802), the grip objective planning unit 102 selects a combination candidate for which the calculated grip evaluation value is maximized (step S805), and checks whether or not the grip evaluation value is equal to or more than a predetermined threshold (step S806).

Then, if the grip evaluation value of the selected combination candidate is equal to or more than the predetermined threshold (Yes in step S806), the grip objective planning unit 102 outputs the combination candidate of the grip surface and the finger as the grip objective 114 (step S807), and ends this processing.

Furthermore, if the grip evaluation value of the selected combination candidate is less than the predetermined threshold (No in step S806), the grip objective planning unit 102 ends the processing without outputting the grip objective 114. In this case, the grip objective planning unit 102 may notify a user (alternatively, a host system) of a fact that it is difficult to grip the object specified via the interface 105.

### E. Modified Example of Robot Control System

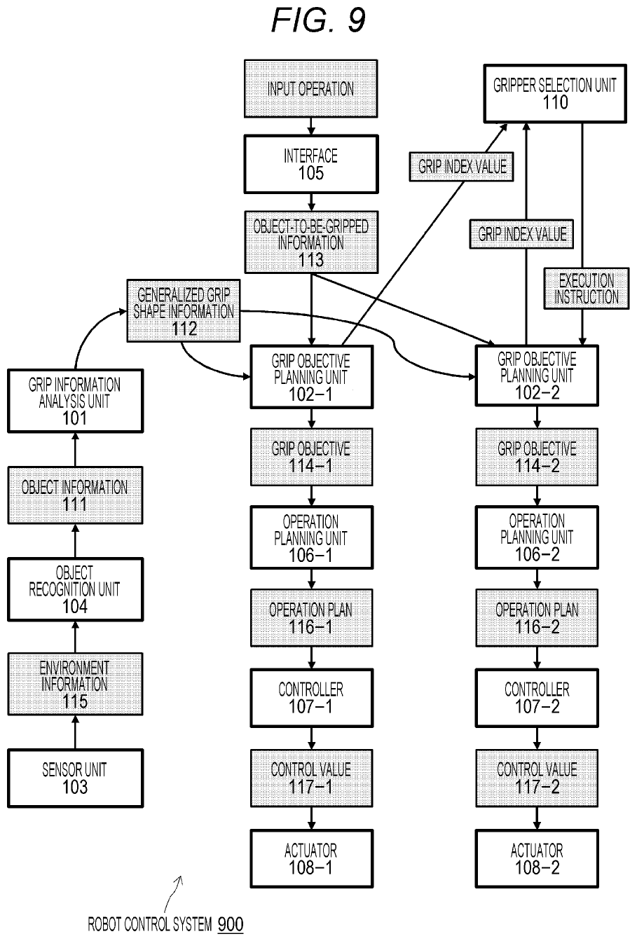

FIG. 9 illustrates functional configurations of a robot control system 900 according to a modified example. Major differences from the robot control system 500 illustrated in FIG. 5 are a point that the robot control system 900 is equipped with a plurality of grippers, assumes selective use of the grippers, and includes the grip objective planning unit 102, the operation planning unit 106, the controller 7, and an actuator 108 for each of the grippers and a point that a gripper selection unit 110 that selects a gripper to grip an object specified via the interface 105.

Each of grip objective planning units 102-1 and 102-2 plans a grip objective of the object with the corresponding gripper and also calculates a grip index value for the planned grip objective. The grip index value is, for example, a value obtained by quantifying at least one of stability, an expected success rate, or an energy consumption amount when the grip objective is executed using the corresponding gripper. Then, the gripper selection unit 110 selects a gripper having the best grip index value from among a plurality of the grip objectives, and instructs the corresponding grip objective planning unit 102 to execute a gripping operation.

Note that the number of grippers to be used is two, and only two control systems are illustrated in FIG. 9 for simplification of the drawing, but the robot control system 900 can use three or more grippers, and can be equipped with control systems corresponding to the number of grippers, and the gripper selection unit 110 can be configured to select a gripper to be used for gripping an object from the three or more grippers.

### F. Apparatus Configuration

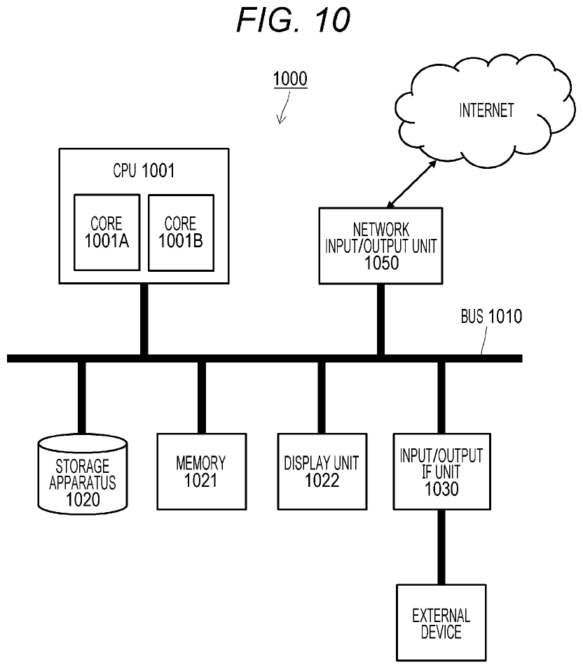

FIG. 10 illustrates a hardware configuration example of an apparatus 1000 operating as the information processing apparatus 100 illustrated in FIG. 1. The illustrated apparatus 1000 may be, for example, a PC, a control unit mounted on a robot, or a server apparatus installed on the Internet.

The apparatus 1000 operates under the overall control of a central processing unit (CPU) 1001. In the illustrated example, the CPU 1001 has a multi-core configuration including a processor core 1001A and a processor core 1001B. The CPU 1001 is interconnected with each component in the apparatus 1000 via a bus 1010.

A storage apparatus 1020 includes, for example, a large-capacity external storage apparatus, such as a hard disk drive (HDD) or a solid state drive (SSD), and stores files such as programs executed by the CPU 1001 and data generated by using the programs during execution or by executing the programs. For example, the CPU 1001 executes a program for performing object recognition on the basis of the environment information 115, a program for analyzing grip information on the basis of the recognized object information 111 and generating the generalized grip shape information 112, a program for planning the grip objective 114 on the basis of the generalized grip shape information 112 and a characteristic of a gripper, a program for planning the operation plan 116 of a manipulator and a gripper from the grip objective 114, a program for calculating a control value of the actuator 108 on the basis of the operation plan 116, and the like.

Furthermore, the storage apparatus 1020 analyzes the grip information on the basis of the object information 111 and accumulates the generalized grip shape information 112 in association with an object type.

A memory 1021 includes a read only memory (ROM) and a random access memory (RAM). The ROM stores, for example, a startup program and basic input/output programs of the apparatus 1000. The RAM is used for loading a program to be executed by the CPU 1001 and temporarily storing data to be used during execution of the program.

A display unit 1022 includes, for example, a liquid crystal display or an organic electro luminescence (EL) display. The display unit 322 displays data and an execution result during execution of a program by the CPU 301. For example, information regarding the object information 111, the generalized grip shape information 112, the grip objective 114, the operation plan 116, and the like is displayed on the display unit 322.

An input/output interface unit 1030 transmits and receives data to and from an external device. The external device is, for example, an input apparatus such as a keyboard or a mouse, or an output apparatus such as a speaker. For example, the input/output interface unit 1030 performs processing for receiving the object-to-be-gripped information 113 from an input operation of the user (alternatively, a host system).

A network input/output unit 1050 performs input/output processing between the apparatus 1000 and the Internet. The network input/output unit 1050 supplies a grip objective planned on the basis of, for example, the generalized grip shape information 112 created on the apparatus 1000 and a characteristic of a gripper to an external apparatus (robot or the like) via the Internet.

### G. Effects

Finally, effects brought by the present disclosure will be summarized.

(1) According to the information processing apparatus 100 of the present disclosure, the grip information analysis unit 101 is configured to divide a surface shape of an object into a plurality of flat surfaces or curved surfaces and calculate generalized grip shape information including grip characteristics (flatness, friction, strength, normal line information, an opening distance, and the like) for each of the divided surfaces. The generalized grip shape information is information regarding a shape of the object not depending on a characteristic of a gripper. Therefore, the grip objective planning unit 102 can determine the best combination of a grip surface and a finger of the gripper on the basis of characteristics of the respective fingers of the gripper and the grip characteristics of the respective divided surfaces. According to the present disclosure, a grip objective can be planned on the basis of the generalized grip shape information of the object even if replacement with a gripper having a different characteristic is performed. In short, it is possible to use the common grip information analysis unit 102 for all the gripper characteristics and to reduce the amount of calculation.

(2) According to the present disclosure, the grip objective planning unit 102 determines the best combination of the grip surface and the finger of the gripper on the basis of the characteristics of the respective fingers of the gripper and the grip characteristics of the respective divided surfaces. Therefore, it is possible to plan a grip objective for a plurality of grippers having different characteristics using the common grip information analysis unit 101.

(3) According to the present disclosure, it is possible to plan grip objectives respectively for the plurality of grippers having different characteristics, compare grip index values of the grip objectives of the respective grippers, and select the best gripper to perform an object gripping operation.

### INDUSTRIAL APPLICABILITY

The present disclosure has been described in detail above with reference to specific embodiments. However, it is self-evident that those skilled in the art can make modified examples and substitutions of the embodiments within a scope not departing from a gist of the present disclosure.

According to the present disclosure, it is possible to analyze various objects, which serve as an object to be gripped, and create generalized grip shape information not depending on a gripper characteristic for each of the objects. Then, when an object is gripped using a manipulator of any robot, it is possible to calculate a grip objective suitable for a characteristic of a gripper that is actually used for gripping the object by using the generalized grip shape information corresponding to the object. Therefore, according to the present disclosure, it is possible to flexibly cope with replacement of a hand of a robot and selection of a hand in a robot equipped with a plurality of hands and to implement an object gripping operation based on the optimum grip objective.

In short, the present disclosure has been described in the form of exemplification, and the contents described in the present specification should not be interpreted in a limited manner. In order to determine the gist of the present disclosure, the scope of claims should be taken into consideration.

Note that the present disclosure can have the following configurations.

(1) An information processing apparatus including:

a grip information analysis unit that analyzes an object and generates generalized grip shape information; and

a generalized grip shape information accumulation unit that accumulates the generalized grip shape information.

(2) The information processing apparatus according to (1) described above, in which

the grip information analysis unit analyzes information of the object including at least one of a position, a posture, a shape, an estimated material, strength, a weight, or a centroid position of the object, and generates the generalized grip shape information for each object type.

(3) The information processing apparatus according to (1) or (2) described above, in which

the grip information analysis unit divides a surface shape of the object into a plurality of flat surfaces or curved surfaces, and generates the generalized grip shape information including at least one of flatness, friction, strength, normal line information, or an opening distance calculated for each of the divided surfaces.

(4) The information processing apparatus according to (2) or (3) described above, in which

the grip information analysis unit estimates the centroid position of the object on an assumption of a uniform material from the shape, a volume, or an appearance of the object.

(5) The information processing apparatus according to (2) or (3) described above, in which

the grip information analysis unit obtains centroids respectively for estimated materials of the object including a plurality of materials and estimates the centroid position by taking a weighted average of the centroids.

(6) The information processing apparatus according to any one of (3) to (5) described above, in which

the grip information analysis unit extracts the surface shape of the object, divides the surface shape of the object into the plurality of flat surfaces or curved surfaces, and, for each of the divided surfaces, estimates the flatness and a normal direction of the surface on the basis of a variance of elements constituting the surface, estimates an opening distance in the normal direction of the divided surface on the basis of the normal direction, and estimates the friction and the strength of the object on the basis of the flatness, reflected light, or an estimated material to generate the generalized grip shape information.

(7) The information processing apparatus according to any one of (1) to (6) described above, further including

a grip objective planning unit that plans a grip objective of the object on the basis of the generalized grip shape information of the object and a characteristic of a gripper to be used for a grip.

(8) The information processing apparatus according to (7) described above, in which

the grip objective planning unit plans the grip objective regarding how to grip which portion of the object.

(9) The information processing apparatus according to (7) or (8) described above, in which

the grip objective planning unit plans the grip objective including at least one of a contact surface, a contact direction, or a contact force of each of fingers of the gripper that comes into contact with the object, the gripper gripping the object.

(10) The information processing apparatus according to any one of (7) to (9) described above, in which

the grip objective planning unit selects a divided surface to be a grip surface candidate from among a plurality of divided surfaces obtained by dividing a surface shape of the object, which is an object to be gripped and determines a combination of the grip surface and a finger of the gripper from among a plurality of the grip surface candidates to determine the grip objective.

(11) The information processing apparatus according to (10) described above, in which

the grip objective planning unit evaluates a suitability of a grip of each of the divided surfaces of the object, which is the object to be gripped, on the basis of a characteristic of the finger of the gripper to be used for gripping the object, and removes a divided surface that is not suitable for the grip from the candidates.

(12) The information processing apparatus according to (11) described above, in which

in a case where the gripper has a plurality of the fingers having different characteristics, the grip objective planning unit evaluates the suitability of the grip of each of the divided surfaces of the object on the basis of the characteristics of the respective fingers.

(13) The information processing apparatus according to (11) or (12) described above, in which

the grip objective planning unit evaluates the suitability of the grip of each of the divided surfaces of the object using at least one of pieces of following (a) to (d) as an evaluation item:

(a) a thickness of the finger of the gripper and an opening distance of the divided surface in a normal direction;

(b) a friction coefficient of the finger and an estimated friction coefficient of the divided surface, a gripping force, and slipperiness of the finger with respect to the divided surface based on an estimated weight of the object;

(c) an elastic modulus of the finger and flatness of the divided surface; and

(d) an angle formed by a vector from an estimated centroid position of the object, which is the object to be gripped, to the divided surface and the normal direction of the divided surface.

(14) The information processing apparatus according to any one of (10) to (13) described above, in which

the grip objective planning unit determines a best combination of the grip surface and the finger of the gripper on the basis of a vector of a gripping force (including a frictional force) generated by each of the fingers gripping the object.

(15) The information processing apparatus according to any one of (7) to (14) described above, in which

in a case where any of a plurality of the grippers is selected to grip the object,

the grip objective planning unit plans the grip objective for each of the plurality of grippers, and

selects a gripper to be used for gripping the object on the basis of a result of comparing the grip objectives of the respective grippers.

(16) The information processing apparatus according to (15) described above, in which

the gripper to be used for gripping the object is selected on the basis of a grip index value including at least one of grip stability when the grip objective of each of the grippers is executed, an expected success rate, or an energy consumption amount.

(17) The information processing apparatus according to any one of (7) to (16) described above, in which

the grip objective planning unit takes the generalized grip shape information regarding the object, which is an object to be gripped, from the generalized grip shape information accumulation unit and plans the grip objective.

(18) The information processing apparatus according to any one of (1) to (17) described above, further including:

an interface configured to specify the object which is an object to be gripped;

an operation planning unit that plans operations of a manipulator and a gripper on the basis of the grip objective planned by the grip objective planning unit;

a controller that generates a control value for driving an actuator on the basis of an operation plan planned by the operation planning unit; and

the actuator that is driven according to the control value generated by the controller to operate the manipulator and the gripper.

(19) An information processing method including:

a grip information analysis step of analyzing an object and generating generalized grip shape information; and

a generalized grip shape information accumulation step of accumulating the generalized grip shape information in a generalized grip shape information accumulation unit.

(20) A computer program recorded in a computer-readable format to cause a computer to function as:

a grip information analysis unit that analyzes an object and generates generalized grip shape information; and

a generalized grip shape information accumulation unit that accumulates the generalized grip shape information.

### REFERENCE SIGNS LIST

100 Information processing apparatus
101 Grip information analysis unit
102 Grip objective planning unit
103 Sensor unit
104 Object recognition unit
105 Interface
106 Operation planning unit
107 Controller
108 Actuator
109 Generalized grip shape information accumulation unit
110 Gripper selection unit
500 Robot control system
900 Robot control system
1000 Apparatus
1001 CPU
1001A, 1001B Processor core
1010 Bus
1020 Storage apparatus
1021 Memory
1022 Display unit
1030 Input/output interface unit
1050 Network input/output unit

1. An information processing apparatus comprising:
a grip information analysis unit that analyzes an object and generates generalized grip shape information; and
a generalized grip shape information accumulation unit that accumulates the generalized grip shape information.

2. The information processing apparatus according to claim 1, wherein
the grip information analysis unit analyzes information of the object including at least one of a position, a posture, a shape, an estimated material, strength, a weight, or a centroid position of the object, and generates the generalized grip shape information for each object type.

3. The information processing apparatus according to claim 1, wherein
the grip information analysis unit divides a surface shape of the object into a plurality of flat surfaces or curved surfaces, and generates the generalized grip shape information including at least one of flatness, friction, strength, normal line information, or an opening distance calculated for each of the divided surfaces.

4. The information processing apparatus according to claim 2, wherein
the grip information analysis unit estimates the centroid position of the object on an assumption of a uniform material from the shape, a volume, or an appearance of the object.

5. The information processing apparatus according to claim 2, wherein
the grip information analysis unit obtains centroids respectively for estimated materials of the object including a plurality of materials and estimates the centroid position by taking a weighted average of the centroids.

6. The information processing apparatus according to claim 3, wherein
the grip information analysis unit extracts the surface shape of the object, divides the surface shape of the object into the plurality of flat surfaces or curved surfaces, and, for each of the divided surfaces, estimates the flatness and a normal direction of the surface on a basis of a variance of elements constituting the surface, estimates an opening distance in the normal direction of the divided surface on a basis of the normal direction, and estimates the friction and the strength of the object on a basis of the flatness, reflected light, or an estimated material to generate the generalized grip shape information.

7. The information processing apparatus according to claim 1, further comprising
a grip objective planning unit that plans a grip objective of the object on a basis of the generalized grip shape information of the object and a characteristic of a gripper to be used for a grip.

8. The information processing apparatus according to claim 7, wherein
the grip objective planning unit plans the grip objective regarding how to grip which portion of the object.

9. The information processing apparatus according to claim 7, wherein
the grip objective planning unit plans the grip objective including at least one of a contact surface, a contact direction, or a contact force of each of fingers of the gripper that comes into contact with the object, the gripper gripping the object.

10. The information processing apparatus according to claim 7, wherein
the grip objective planning unit selects a divided surface to be a grip surface candidate from among a plurality of divided surfaces obtained by dividing a surface shape of the object, which is an object to be gripped and determines a combination of the grip surface and a finger of the gripper from among a plurality of the grip surface candidates to determine the grip objective.

11. The information processing apparatus according to claim 10, wherein
the grip objective planning unit evaluates a suitability of a grip of each of the divided surfaces of the object, which is the object to be gripped, on a basis of a characteristic of the finger of the gripper to be used for gripping the object, and removes a divided surface that is not suitable for the grip from the candidates.

12. The information processing apparatus according to claim 11, wherein
in a case where the gripper has a plurality of the fingers having different characteristics, the grip objective planning unit evaluates the suitability of the grip of each of the divided surfaces of the object on a basis of the characteristics of the respective fingers.

13. The information processing apparatus according to claim 11, wherein
the grip objective planning unit evaluates the suitability of the grip of each of the divided surfaces of the object using at least one of pieces of following (a) to (d) as an evaluation item:
(a) a thickness of the finger of the gripper and an opening distance of the divided surface in a normal direction;
(b) a friction coefficient of the finger and an estimated friction coefficient of the divided surface, a gripping force, and slipperiness of the finger with respect to the divided surface based on an estimated weight of the object;
(c) an elastic modulus of the finger and flatness of the divided surface; and
(d) an angle formed by a vector from an estimated centroid position of the object, which is the object to be gripped, to the divided surface and the normal direction of the divided surface.

14. The information processing apparatus according to claim 10, wherein
the grip objective planning unit determines a best combination of the grip surface and the finger of the gripper on a basis of a vector of a gripping force (including a frictional force) generated by each of the fingers gripping the object.

15. The information processing apparatus according to claim 7, wherein
in a case where any of a plurality of the grippers is selected to grip the object,
the grip objective planning unit plans the grip objective for each of the plurality of grippers, and
selects a gripper to be used for gripping the object on a basis of a result of comparing the grip objectives of the respective grippers.

16. The information processing apparatus according to claim 15, wherein
the gripper to be used for gripping the object is selected on a basis of a grip index value including at least one of grip stability when the grip objective of each of the grippers is executed, an expected success rate, or an energy consumption amount.

17. The information processing apparatus according to claim 7, wherein
the grip objective planning unit takes the generalized grip shape information regarding the object, which is an object to be gripped, from the generalized grip shape information accumulation unit and plans the grip objective.

18. The information processing apparatus according to claim 1, further comprising:
an interface configured to specify the object which is an object to be gripped;
an operation planning unit that plans operations of a manipulator and a gripper on a basis of the grip objective planned by the grip objective planning unit;
a controller that generates a control value for driving an actuator on a basis of an operation plan planned by the operation planning unit; and
the actuator that is driven according to the control value generated by the controller to operate the manipulator and the gripper.

19. An information processing method comprising:
a grip information analysis step of analyzing an object and generating generalized grip shape information; and
a generalized grip shape information accumulation step of accumulating the generalized grip shape information in a generalized grip shape information accumulation unit.

20. A computer program recorded in a computer-readable format to cause a computer to function as:
a grip information analysis unit that analyzes an object and generates generalized grip shape information; and
a generalized grip shape information accumulation unit that accumulates the generalized grip shape information.
